(19) United States
(12) Patent Application Publication
(10) Pub. No.: US 2006/0277215 A1
(43) Pub. Date: Dec. 7, 2006

(54) Health-care related database middleware

(76) Inventor: Jason Siegel, Calabasas, CA (US)

Correspondence Address: PERKINS COIE LLP, P.O. BOX 2168, MENLO PARK, CA, 94026, US

(21) Appl. No.: 11/431,900

(22) Filed: May 9, 2006

Related U.S. Application Data
(60) Provisional application No. 60/679,429, filed on May 9, 2005.
(60) Provisional application No. 60/718,951, filed on Sep. 19, 2005.

(51) Int. Cl. G06F 17/00

(52) U.S. Cl. 707/104.1

(57) ABSTRACT

An exemplary embodiment providing for one or more improvements includes a database translation architecture that has an object model for defining a variety of health-related classes and a plurality of data bridge/data set pairs wherein each data bridge is coupled to the object model. A plurality of external components are coupled to all but one of the data bridge/data set pairs of the plurality of data bridge/data set pairs wherein the plurality of external components are operative to send and receive data in formats unique to each external component such that each format is translated to and from the object model by each corresponding data bridge/data set pair. Also included is a database coupled to a remaining data bridge/data set pair not coupled to an external component wherein the database is responsive to data queries from the object model as translated by the remaining data bridge/data pair and the database and operative to deliver requested data back to the object model through the remaining data bridge/data set pair which is in turn sent to an external component that originally initiated the data query.

### RELATED APPLICATIONS

Priority is claimed under 35 USC 120 and/or 35 USC 119(e) to: U.S. patent application Ser. No. 60/679,429, filed May 9, 2005, entitled “HEALTH-CARE RELATED DATABASE MIDDLEWARE”; and U.S. patent application Ser. No. 60/718,951, filed Sep. 19, 2005, entitled “HEALTH-CARE RELATED DATABASE MIDDLEWARE”, each of which applications are incorporated by reference herein.

### BACKGROUND

Health Level 7 (“HL7”) is a healthcare information technology (“IT”) standards body that is responsible for establishing the messaging protocols for the electronic transmission of information among IT systems used in the healthcare industry. The HL7 communications protocols allow IT systems offered by different solutions providers (and even different systems offered by the same solutions provider) to communicate with each other in a standardized fashion. Laboratory Information Systems (“LIS”), Hospital Information Systems (“HIS”), Electronic Medical Records systems (“EMR”) and specialized systems that facilitate Computerized Physician Order Entry (“CPOE”) are among the types of systems used by healthcare providers that typically support HL7 messaging as a standard method for communication. When information originated by one system must be shared with others, those systems are likely to require a specialized interface to do so. This is almost always true when the communication is between unrelated healthcare institutions, but it can also occur when systems within the same institution need to communicate.

The LIS, HIS and other healthcare IT systems produce information that is important to the diagnosis and treatment of patients. At times, this information is important to public health officials; most of the information that public health officials act upon in investigating incidents of communicable disease comes from reports of diagnostic test results confirming the incidence of infectious disease in a patient. As a result, electronic communication between LIS, HIS and other healthcare IT systems and the systems used by public health officials is important. For example, if a laboratory receives a diagnostic test result indicating that a patient may have a communicable disease, the laboratory is usually required by law to notify designated public health officials of the existence of the condition. Depending upon the circumstances, the physician who has ordered the test may also be required to report the positive test result to the public health department. While this type of reporting has traditionally been handled using manual processes such as telephonic reporting and/or mail or fax transmission of paper forms, the transmission of this information can be (and increasingly is being) handled in an automated fashion, using system-to-system communications often employing point-to-point interfaces. In situations where one or more steps in the notification process are handled electronically, the HL7 protocol has been the typical method of transmission. For reasons stated below, it is now the method mandated by the federal government.

As a result of a federal government initiative under the direction and control of the Centers for Disease Control and Prevention in Atlanta (“CDC”), a framework of coordinated standards and specifications, called the Public Health Information Network (“PHIN”), is now being advanced to facilitate the electronic transmission of information about communicable disease incidents from local public health departments to the CDC. PHIN will also perhaps facilitate the sharing of information among public health departments nationally. While the system was originally conceived as a disease surveillance network, in recent years its mandate has been expanded to include detection of incidents or outbreaks events that may indicate a bio-terrorist attack has occurred or is taking place. The CDC's vision for this network depends upon communication among healthcare providers, local, state and public health officials. The CDC might have mandated that all of these potential participants in the network use the same IT system to communicate. Instead, it chose to delegate responsibility for the deployment of IT systems to the participants themselves, leaving each free to adapt existing systems, build or buy new ones, so long as these systems were “interoperable” based upon criteria established by the CDC. One of the primary criteria for determining “interoperability” is the capability of each system to transmit messages using a standard format and structure. The CDC has adopted HL7 as the standard protocol for the format and structure of the data components of messages to be communicated across the Network.

While HL7 is widely used in the healthcare industry, it is not without its deficiencies. For example, the HL7 version 2 protocol is “flat”. That is, it is not capable of sending nested information. Additionally, sometimes it is necessary to describe new events that are not part of the standard HL7 version 2 codes. As a result, new terms are implemented in free form or free text segments (so called “Z” segments). The problem with Z segments is that, by their nature, they hold information that (i) is unique to a particular institution and unlikely to be readily understood by other institutions, (ii) is of a type that cannot be accommodated in any other HL7 segment, and(iii) is in a format that is far more difficult to standardize. As a result, this dependence on the Z segment for the communication of important information undermines the utility of the HL7 “standard”.

To overcome these deficiencies, HL7 conceived the version 3 Reference Information Model (“RIM”). The RIM is a static model of health and health care information as viewed within the scope of HL7 standards development activities. The formal representation of the RIM in messages employs the extensible markup language (“XML”). The RIM was designed in part to offer a more robust message structure that could accommodate the types of information traditionally communicated in Z segments. The CDC has specified that PHIN compliant systems should use both HL7 v2.x and HL7 v3.0 RIM messages.

In attempting to achieve interoperability for systems communicating across the Public Health Information Network, the CDC has had to deal with more than a standard messaging protocol. It has identified a wide variety of functions and specifications for “PHIN-compliant” systems. For example, the effort to ensure that all PHIN systems are capable of transmitting, receiving, storing and retrieving relevant information has led it to consider the optimal structure for the database within each system. By dictating the model that each system's database must follow, the CDC apparently has tried to ensure that PHIN-compliant systems will be able to handle the widest possible spectrum of data—including data about known diseases and typical incidents, as well as diseases that are as yet undiscovered, incidents never before observed, etc. The CDC has decided that the HL7 RIM—the model for the version 3.0 messaging structure, that is designed to allow for communication of a wide variety of “non-standard” information—should serve as the model for storage and retrieval of information communicated over the PHIN. That is, the CDC is requiring that data communicated using the HL7 RIM-based messaging standard should also be the schema for a database, the model for which is “derived from or directly mappable to the RIM”. While this may seem logical to the layperson, structuring a database on a model behind a communications protocol is atypical, as the requirements that must be supported by a messaging standard are far different from those that would need to be addressed when designing an efficient, scalable database. Developing a RIM-based database that can perform up to the expectations of typical users of software solutions has proven challenging.

While PHIN-compliance is a major factor driving the need to overcome this challenge the RIM's usefulness goes beyond this regulatory impetus. A database modeled on the RIM would offer greater extensibility allowing RIM-based IT systems to better adapt to the ever-changing requirements of medical informatics necessitated by advances in medical science.

Existing healthcare IT systems (including those employed by public health officials) are likely to support communication using HL7 standards. In addition, many support HL7 v. 2.x messages. However, these systems generally do not employ databases derived from or directly mappable to the RIM. The issue is further compounded in that each health institution will typically need to identify its existing data requirements, including (for example) the vocabularies it uses to label data elements, before communicating or writing that data to a database modeled on the RIM. As a result, unique implementations will be required to map each Network participant's data to a PHIN-compliant database.

In view of the foregoing, it may be useful to provide methods and systems that facilitate the mapping and storage of various disparate health-related data records to a RIM-compliant database.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

An embodiment by way of a non-limiting example includes a database translation architecture that has an object model for defining a variety of health-related classes and a plurality of data bridge/data set pairs wherein each data bridge is coupled to the object model. A plurality of external components are coupled to all but one of the data bridge/data set pairs of the plurality of data bridge/data set pairs wherein the plurality of external components are operative to send and receive data in formats unique to each external component such that each format is translated to and from the object model by each corresponding data bridge/data set pair. Also included is a database coupled to a remaining data bridge/data set pair not coupled to an external component wherein the database is responsive to data queries from the object model as translated by the remaining data bridge/data pair and the database and operative to deliver requested data back to the object model through the remaining data bridge/data set pair which is in turn sent to an external component that originally initiated the data query. Further, in additional embodiments, a concept descriptor is utilized. The concept descriptor uniquely identifies blocks of data for storage and retrieval. Moreover, the concept descriptor allows for well-defined, but new, datatypes to be consumed by the database.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in the referenced figures of the drawings. It is intended that the embodiments and figures disclosed herein are to be considered illustrative rather than limiting.

FIG. 1 illustrates a block diagram of a middleware architecture capable of translating data into a RIM compliant data structure, in accordance with an particular implementation;

FIG. 2 illustrates a data model used in the database server of FIG. 1, in accordance with an exemplary embodiment;

FIG. 3 is a class interaction diagram illustrating an exemplary data flow of the architecture 10 of FIG. 1, in accordance with an exemplary embodiment;

FIGS. 4-19 illustrate an exemplary physical data model implementation, in accordance with an exemplary embodiment; and

FIG. 20 illustrates a document object model, in accordance with an exemplary embodiment.

FIGS. 21-24 illustrates a concept descriptor, in accordance with an exemplary embodiment.

### DETAILED DESCRIPTION

Aspects of the present invention contemplates methods and systems of constructing a middleware that is capable of being mapped to any graphical user interface such that the collected data is properly received and stored in a RIM compliant manner. This is accomplished by utilizing a two-key primary key composed of an object identifier (“OID”) of a RIM term and the actual term extension, a unified code table which is a relational meta-data structure that has a field that is common to all of the vocabularies in use and a document object model (“DOM”) which defines various relationships between data types. Advantageously, aspects of the present invention allow for any type of graphical user interface to be conveniently mapped such that data collected by these user interfaces are stored in a RIM compliant manner as required by the CDC. These and other advantages will be detailed in subsequent sections.

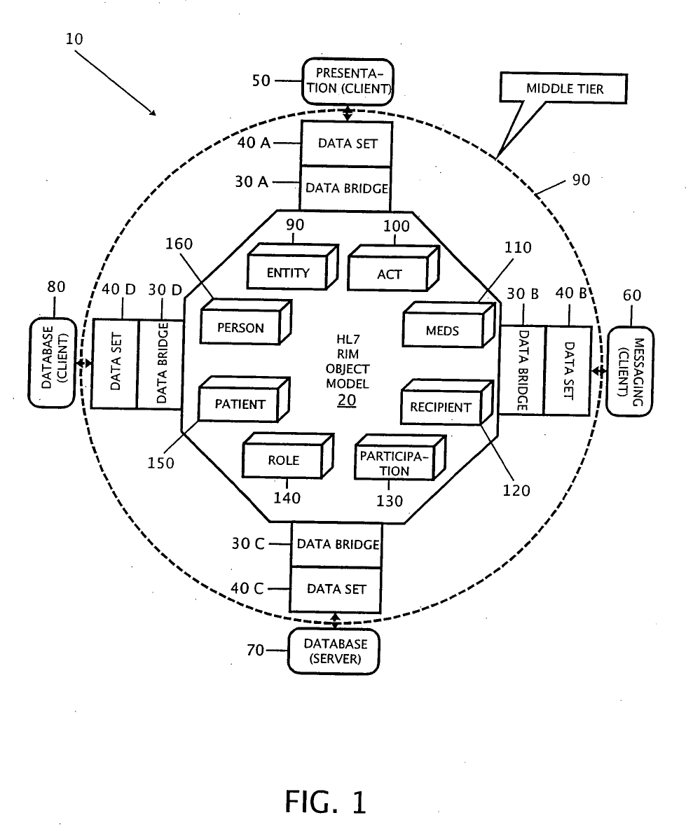

FIG. 1 illustrates a block diagram of a middleware architecture 10 capable of translating data into a RIM compliant data structure, in accordance with a particular implementation. Included in architecture 10 is a document object model 20, various data bridges (30A, 30B, 30C and 30D), associated data sets (40A, 40B, 40C and 40D) and various external interfaces such as a presentation client 50, a messaging client 60, a database server 70 and a database client 80 where data is stored in a RIM compliant manner. For convenience, the internal part of the architecture 10 will be referred to as a middle tier 90.

The middle tier 90 includes a common object-oriented schema that connects to sources and targets through the data bridges (30A, 30B, 30C and 30D) and target specific datasets (40A, 40B, 40C and 40D). The document object model 20 is the central organization of health data and application business logic. The object hierarchy can be derived from the CDC Public Health Logical Data Model 1.0, which itself is derived from the HL7 RIM. A copy of the CDC Public Health Logical Data Model 1.0 user guide is included at appendix C. This provides for a common schema for which data can be transformed and translated into, connecting, for example a database 70 to a user interface such as presentation client 50.

The RIM document object model includes several classes that define the inter-relationships between various sets of data. These classes include entity 90, act 100, medications (“meds”) 110, recipient 120, participation 130, role 140, patient 150 and person 160. To further illustrate what some of thee various classes mean, an entity 90 could be an institution such as a hospital, an act 100 could be prescribing a medication 110, a role 140 could be a doctor and so on.

The data bridges (30A, 30B, 30C and 30D) contains business logic to transfer data between the external interfaces (50, 60, 70 and 80) and the object model 20, using the datasets (40A, 40B, 40C and 40D) as an intermediary data cache. The data bridges (30A, 30B, 30C and 30D) determine which objects need to be instantiated and the attribute values to set. The data bridges (30A, 30B, 30C and 30D) also communicate directly with the datasets (40A, 40B, 40C and 40D) and the object model 20. Some the functions of the data bridges (30A, 30B, 30C and 30D) include object instantiation, object attribute setting, data type translation, computed field calculation, structured query language (“SQL”) dialect calculation, query generation, dataset population, database updates and database trigger logic.

The datasets (40A, 40B, 40C and 40D) contain a representation of select data needed for transfer between client database 80 or server database 70. The datasets (40A, 40B, 40C and 40D) may contain numerous table and views of their relationships as is typically seen in a relational schema. It is intended to be in a format that makes it straight forward to update or derive data from the target data source. If the data source is the server database 70, then dataset 40C will represent data that is needed client database 80 or interfaces 50 and 60. Dataset 40D for interface 80 may be in a format that allows direct bindings from form controls to data fields datasets for a server and datasets for clients may be completely incompatible since the data is first transformed by the various data bridges (30A, 30B, 30C and 30D) into a common schema in the object model 20.

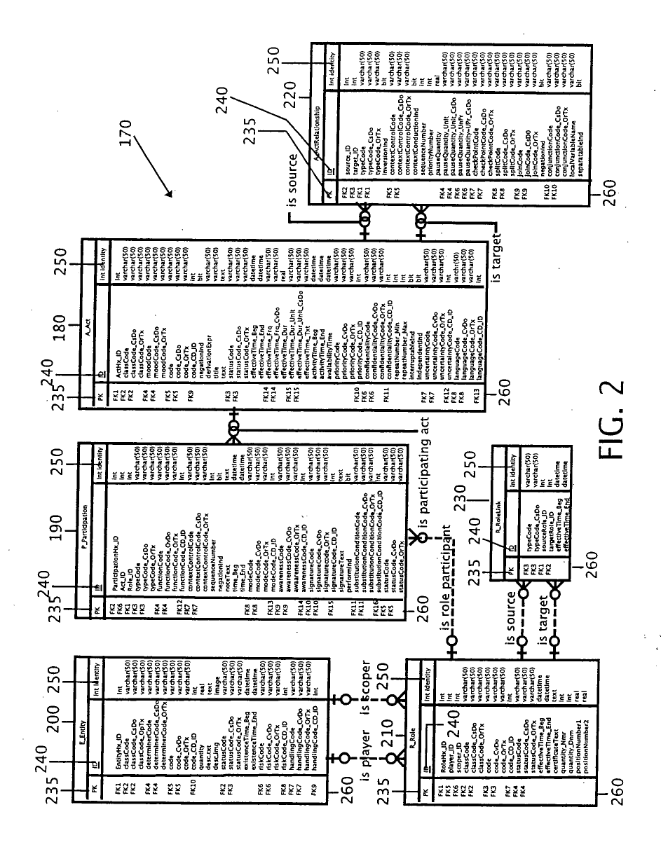

FIG. 2 illustrates a data model 170 used in the database server 70 of FIG. 1, in accordance with an exemplary embodiment. Included in data model 170 are the major RIM classes act 180, participation 190, entity 200, role 210, act relationship 220 and role link 230. Act 180 represents actions that are executed and must be documented as health care is managed and provided. Participation 190 expresses the content for an act 180 in terms of such as who performed it, for whom it was done, etc. Entity 200 represents the physical things and beings that are of interest to and take part in health care. Role 210 establishes the roles that entities 200 play as they participate in health care acts 180. Act relationship 220 represents the binding of one act 180 to another, such as the relationship between an order for an observation and the observation event as it occurs. Role link 230 represents relationships between individual roles 210.

Included in each of the classes of data model 170 is the aforementioned two-key primary key 235 consisting of the OID 240 that a term comes from and the actual term extension 250. Also included are various foreign keys 260 for each individual OID and associated term extension. Foreign keys 260 point to locations in a unified code table (not shown). The unified code table is a relational meta-data structure that has a field that is common to all of the various, differing vocabularies that are employed by the health care industry. A copy of the unified code table can be found in the physical data model that is located at appendix A. In an exemplary embodiment, data model 170 is defined using Microsoft's Visio® software which is capable of building a database and associated data definition files (“.ddl”).

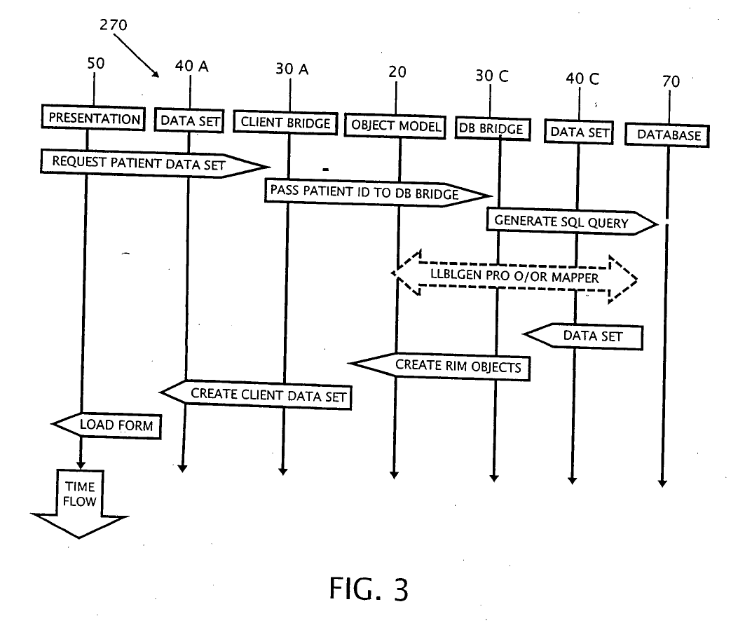

An exemplary data flow of architecture 10 of FIG. 1 will now be described. FIG. 3 is a class interaction diagram illustrating an exemplary data flow of the architecture 10 of FIG. 1, in accordance with an exemplary embodiment. Firstly, a patient dataset is requested from presentation client 50. The request is processed through the data set 40A and the data bridge 30A by passing a patient ID to the object model 20 and data bridge 30C. At the data bridge 30C, an SQL query is generated and sent to database 70 through data set 40C. In response, the requested dataset is sent from the database 70 to the object model 20 via data set 40C and data bridge 30C. During the transfer, RIM objects are created which are then used by the bridge 30A and data set 40A to create a client data set. In conclusion, a form containing the requested data is loaded at interface 50. In a preferred embodiment, an LLBL Gen Pro software tool is employed to automate the process shown in FIG. 3. LLBLGen Pro is a data-access tier generator for .NET and it generates a complete data-access tier and business facade/support tier for use in an existing database schema set.

A specific, exemplary implementation of the invention as it applies to a field-nurse case management (“NCM”) system will now be presented. Nurse case management refers to a component of some public health systems wherein one or more nurses are assigned to track a public health issue to help ensure the health issue does not worsen. For example, there may be a report of widespread food poisoning. It would be the job of the nurses to go out and interview affected individuals in order to isolate the source of the food poisoning. Another example could be follow up with tuberculosis patients to make sure they take their medicine. In each case, various data needs to be recorded and stored in a RIM compliant database. All of the details for the following exemplary implementation can be found at appendix B.

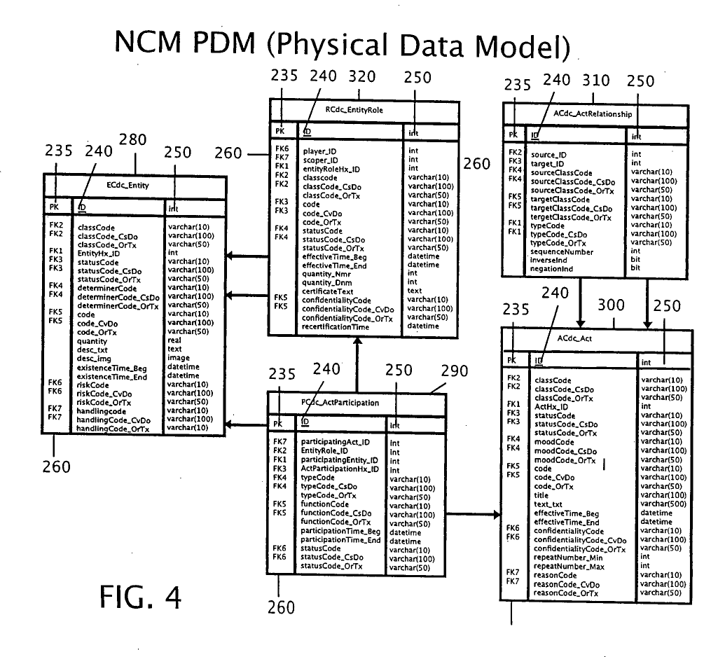

FIGS. 4-19 illustrate an exemplary physical data model implementation, in accordance with an exemplary embodiment. FIG. 4 illustrates the classes and their relationships to each other. The classes include entity 280, act participation 290, act 300, act relationship 310 and entity role 320. Similar to FIG. 2, each class includes a primary key 235, an OID 240, term extensions 250 and foreign keys 260.

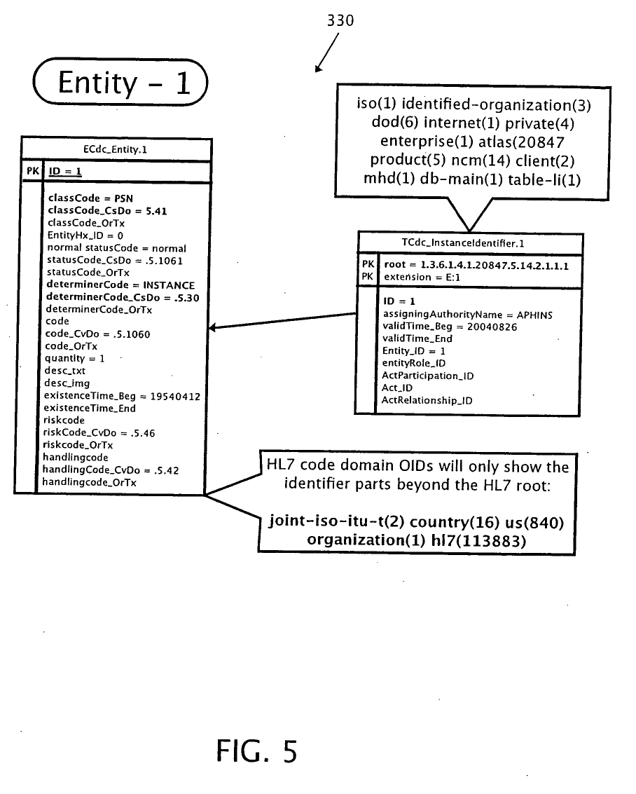

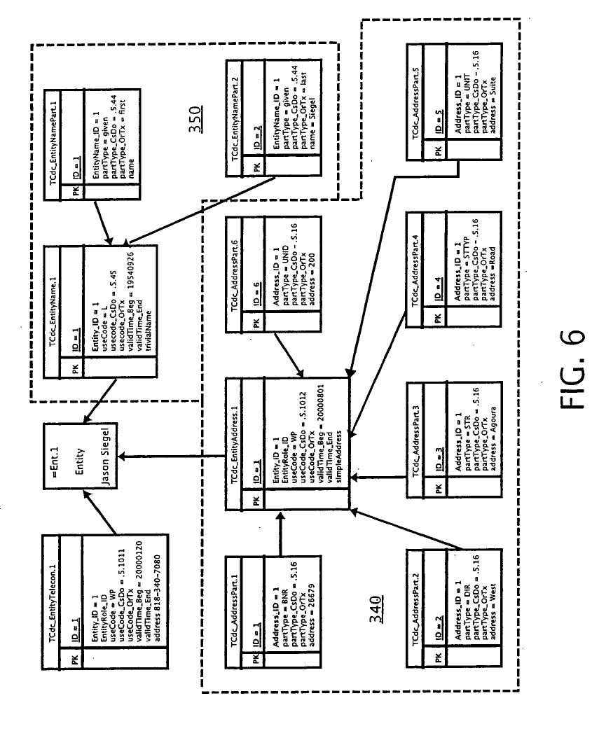

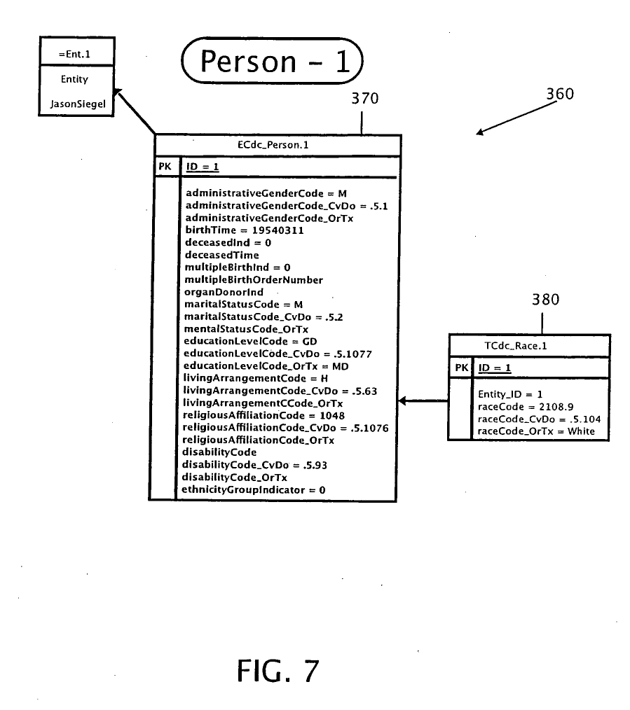

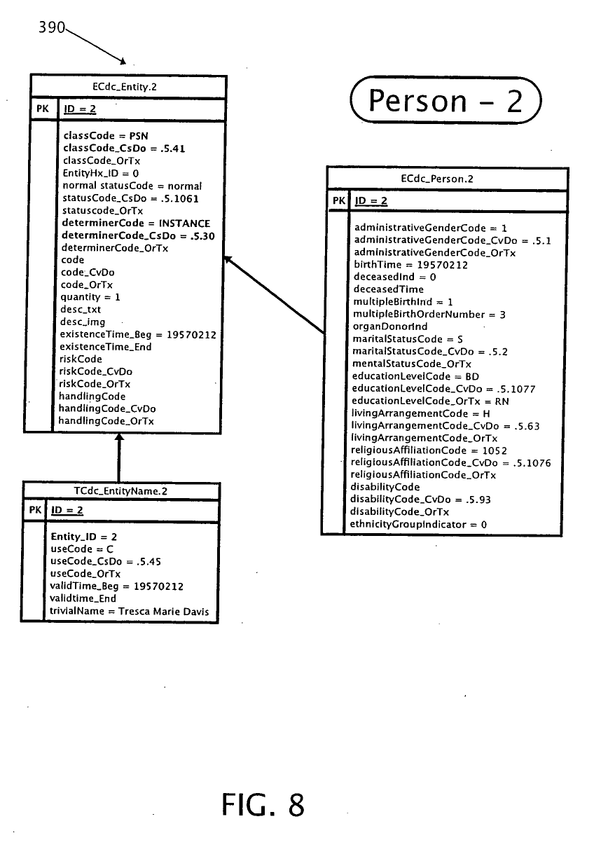

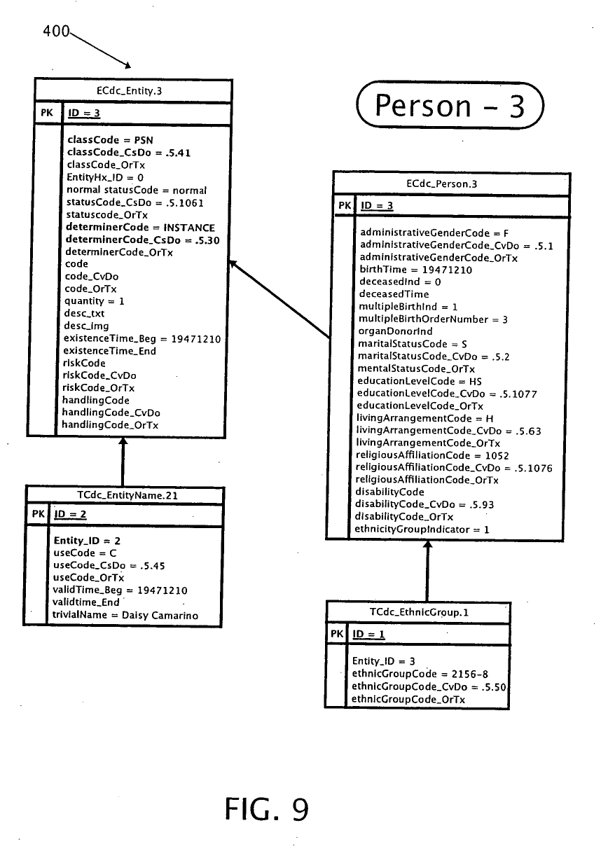

FIGS. 5-6 illustrate how an entity 330 is defined. Some components for defining entity 330 include various address subcomponents 340 and entity name subcomponents 350. After entity 330 is created, further subcomponents can also be defined such as a first person 360. First person 360 is then further defined at 370 and 380 in FIG. 7. In a similar manner, a second person 390 and a third person 400 are defined at FIGS. 8-9.

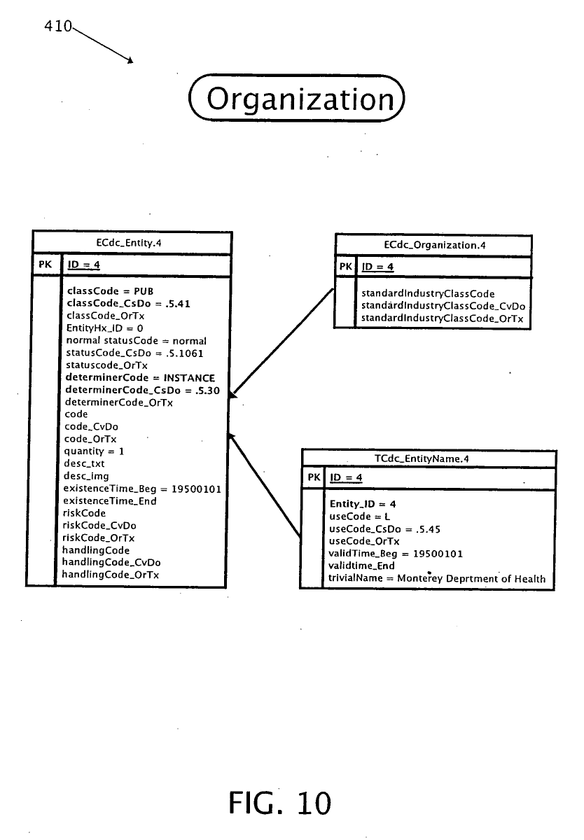

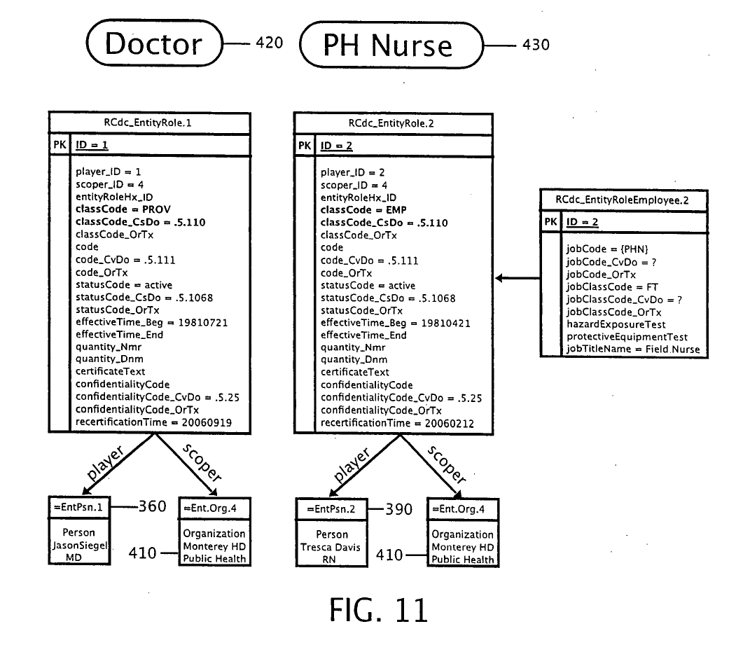

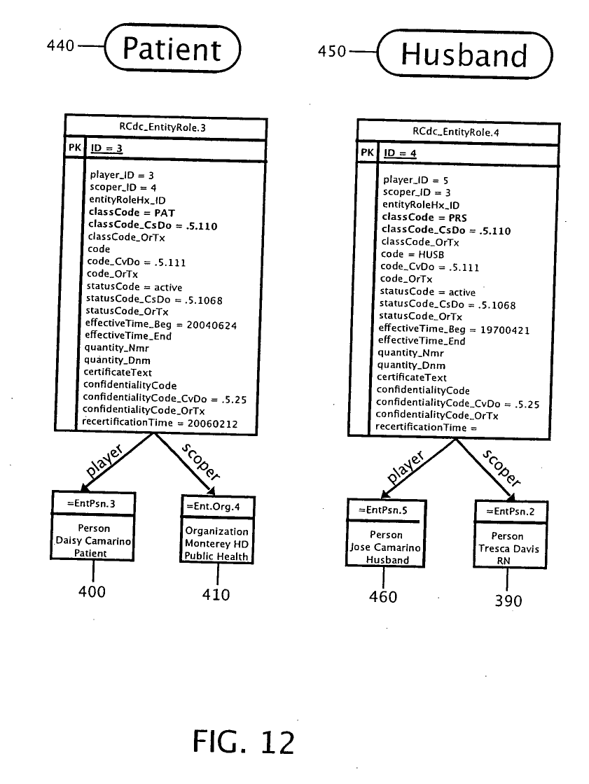

FIG. 10 illustrates an organization 410. In this case, the Monterey Department of Health. Members/roles of that organization could include the first person 360 as a doctor 420 and the second person 390 as a nurse 430 as indicated in FIG. 11. In a similar manner, a patient 440 can also be defined a husband 450 of the patient can also be defined as shown in FIG. 12.

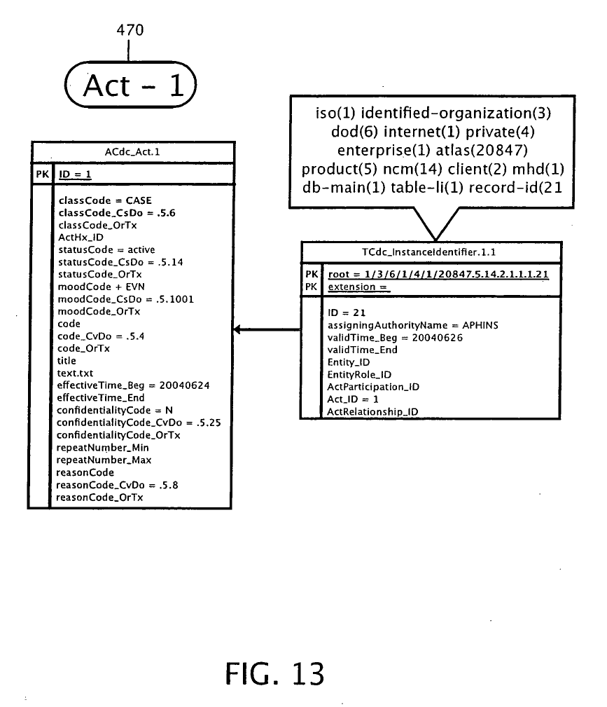

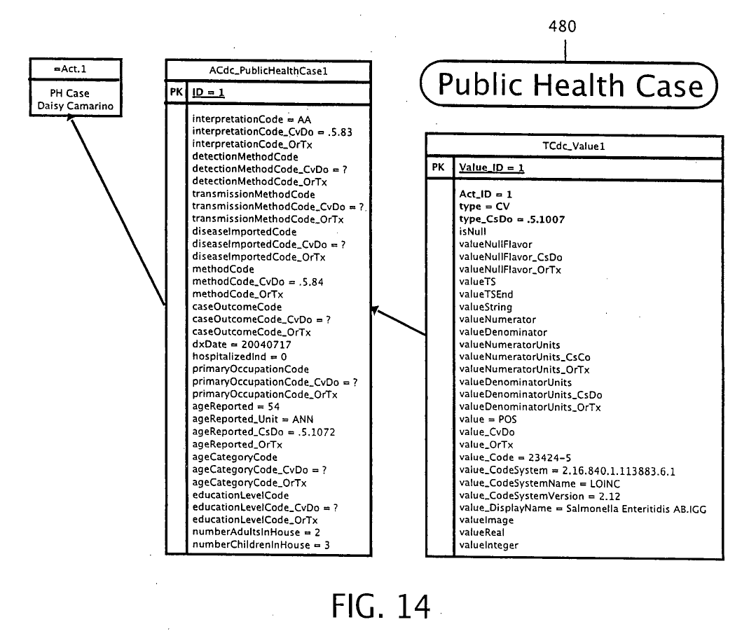

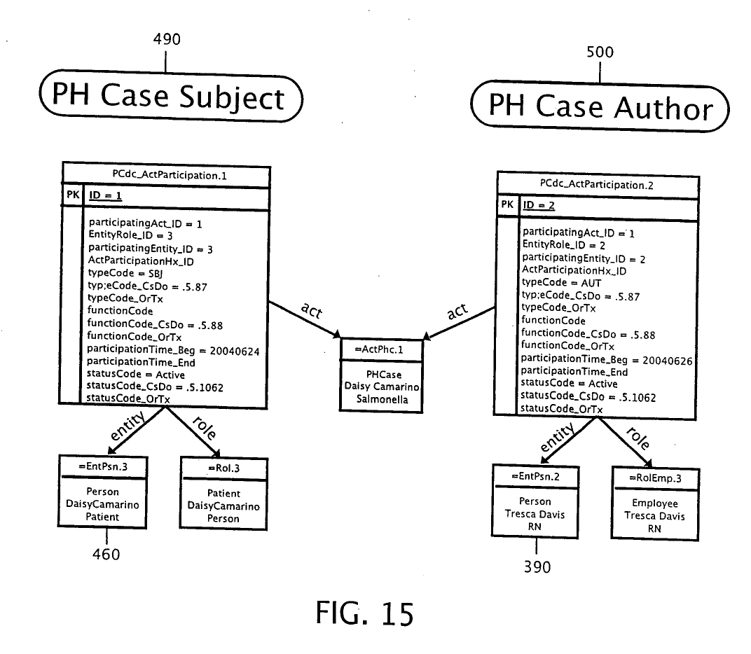

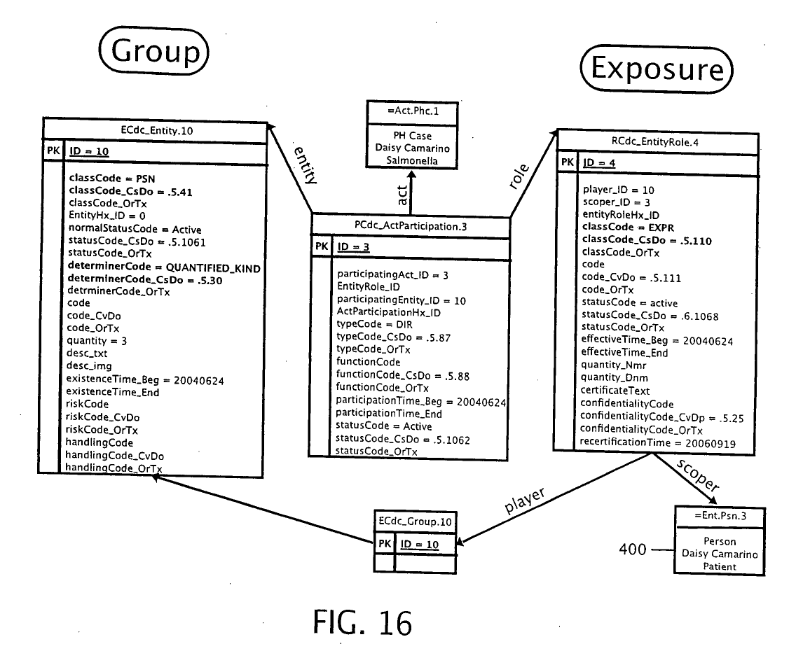

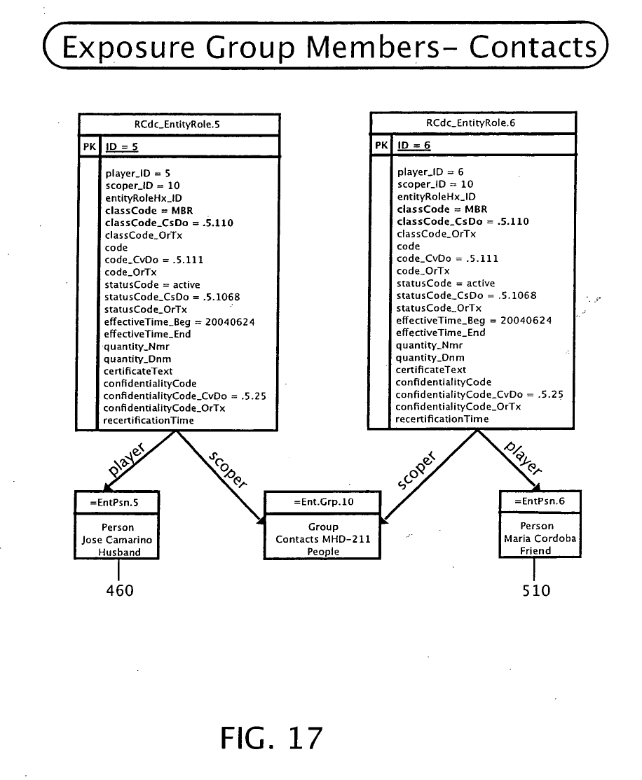

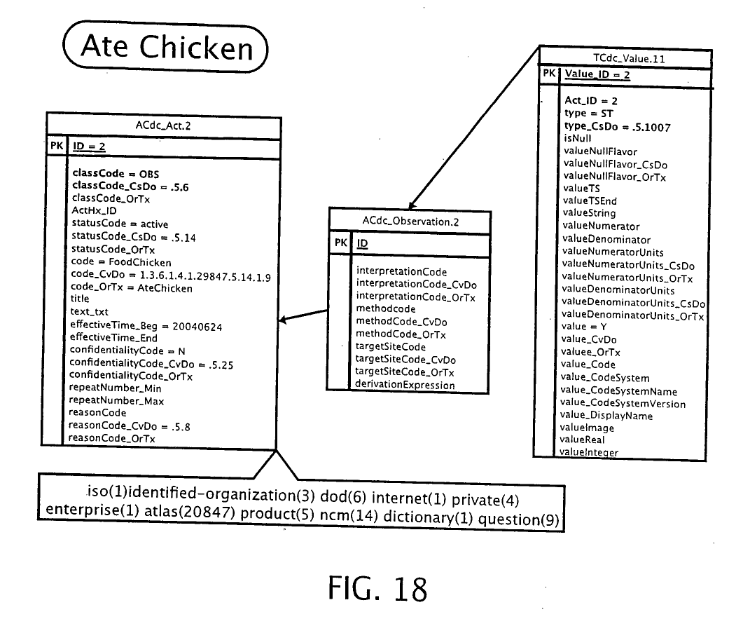

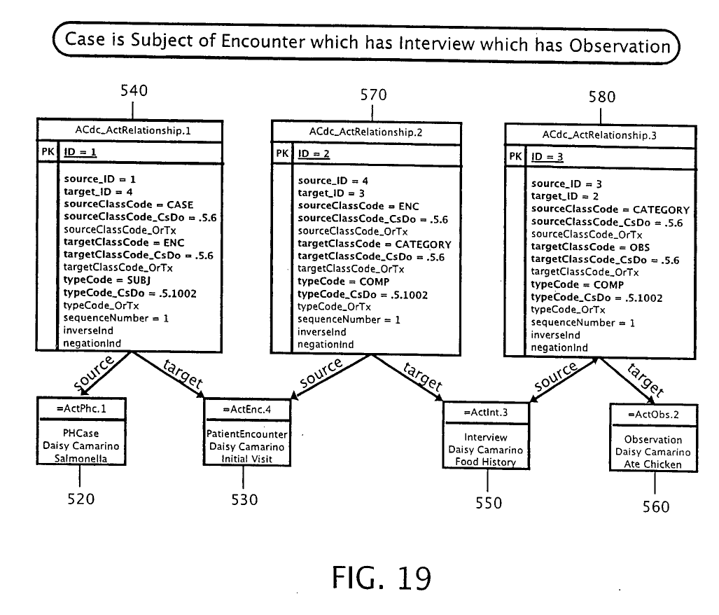

In FIGS. 13-14, an health related incident is reported as an act 470 and a public health case 480 is created. In this particular example, patient Daisy Camarino contracted salmonella. In FIG. 15, a case subject 490 and a case author 500 are created. Here, RN Tresca Davis is assigned to follow up with patient Daisy Camarino to hopefully find out the source of the salmonella. In FIGS. 16-17, the group exposure is determined including an identification of people in the exposure group. Daisy's husband 460 and friend Maria Cordoba 510 have been potentially exposed to the salmonella as well. In FIGS. 18-19, it is determined that chicken is the probable source of the salmonella and the entire observation cycle is recorded as act relationships. That is act 520 of reporting a case of salmonella and act 530 of a nurse visit to the patient are linked to first act relationship 540. In a similar manner, acts 530 and 550 link a second act relationship 570 and acts 550 and 560 link a third act relationship 580.

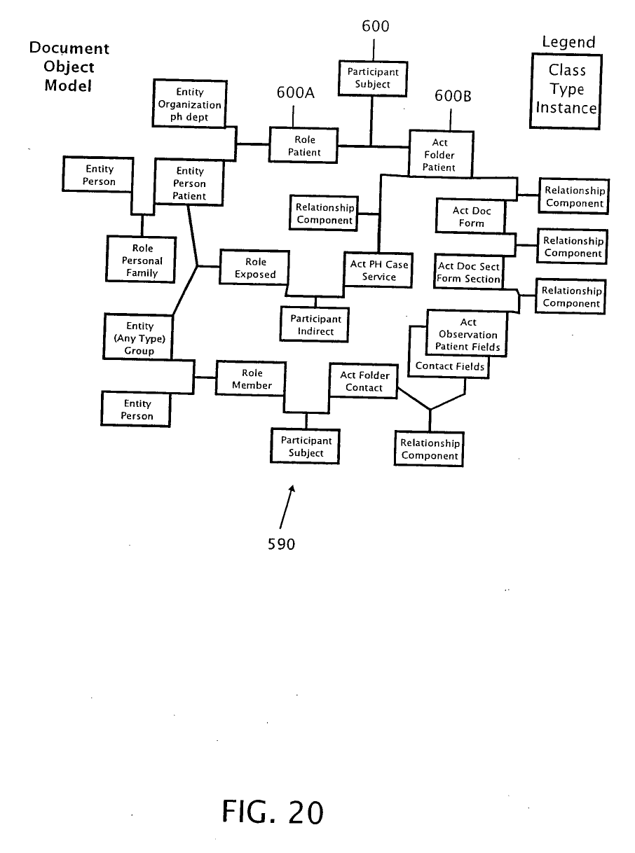

FIG. 20 illustrates a document object model (“DOM”) 590, in accordance with an exemplary embodiment. DOM 590 defines a hierarchical structure for storing the various objects of the present invention. Each object is stored as class, type and instance. For example, object 600 includes a participant class and a subject type. Object 600 can then be further divided into sub-objects 600A and 600B. Object 600A defines a role class and a patient type while object 600B describes an act class, a folder type and a patient instance. In this manner, the various objects are stored in a database.

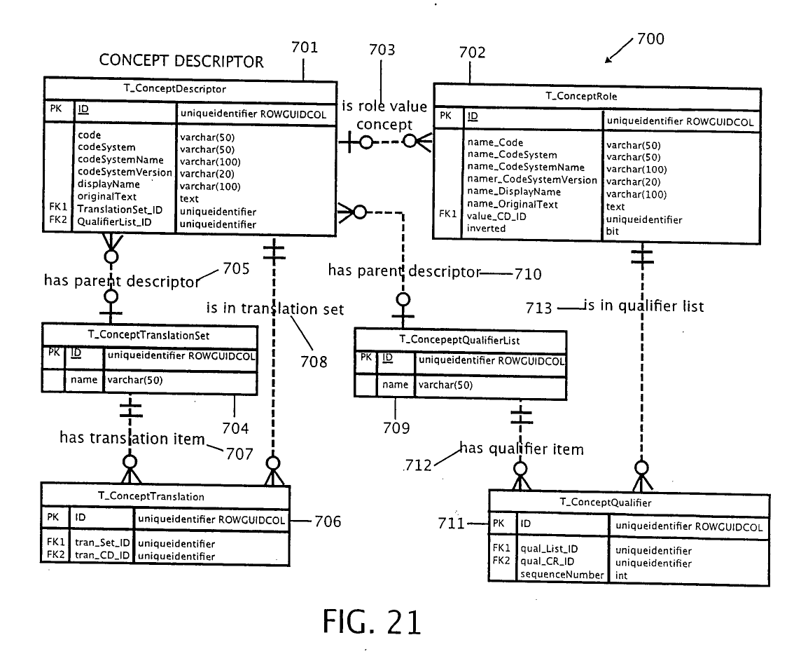

FIG. 21 illustrates a concept descriptor 700, in accordance with an exemplary embodiment. In the embodiment illustrated, the concept descriptor 700 is comprised of six classes. The ConceptDescriptor class 701 is associated with the ConceptRole class 702. The association between these classes is a role value concept 703. Further, the ConceptDescriptor class 701 is associated with the ConceptTranslationSet class 704. The association between these classes is a parent descriptor 705. The ConceptTranslationSet class is also associated with the ConceptTranslation class 706. The association between these classes is a translation item 707. The ConceptTranslation class 706 is additionally associated with the ConceptDescriptor class 701. The association between these classes is the translation list 708. The ConceptDescriptor class 701 is also associated with the ConceptQualifierList class 709. The association between these classes is the parent descriptor 710. The ConceptQualifierList class 709 is further associated with the ConceptQualifier 711 class. The association between these classes is the qualifier item 712. The ConceptQualifier class 711 is additionally associated with the ConceptRole class 702. The association between theses classes is the qualifier list 713. The concept descriptor 700 as described in the exemplary embodiment uniquely identifies and stores blocks of data such that the recursion normally associated with the implementation of a file descriptor is eliminated. Further, the blocks of data are able to be retrieved in the same form as they were received. In addition, the concept descriptor allows for the storage and retrieval of well-defined, but new, datatypes into an existing database.

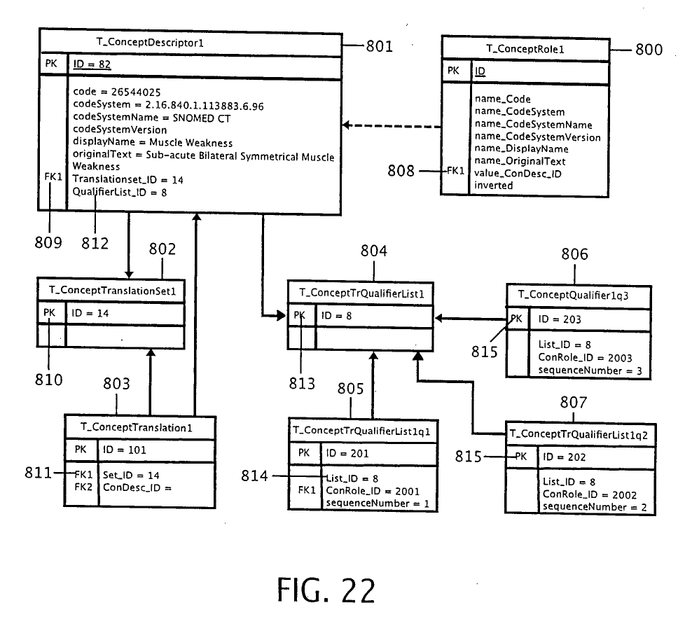

FIG. 22 illustrates an implementation of the concept descriptor in accordance with an exemplary embodiment. In the embodiment illustrated, the ConceptRole1 class 800 contains a foreign key 808. The foreign key references the ConceptDescriptor1 class 801. The ConceptDescriptor1 class also contains a foreign key 809. The foreign key 809 in the ConceptDescriptor1 class 801 references the ConceptTranslationSet1 class 802. The ConceptTranslationSet1 class 802 contains a primary key 810 equal to the foreign key 809 of the ConceptDescriptor1 class 801. The ConceptTranslation1 class 803 contains a foreign key 811 which references and equals both the primary key 810 in the ConceptTranslationSet1 class 802 and the foreign key 809 in the ConceptDescriptor class 801. The ConceptDescriptor1 class 801 also contains a reference 812 to the ConceptQualifierList1 class 804. The reference 812 is equal to the primary key 813 in the ConceptQualifierList1 class 804. The ConceptQualifier1q1 class 805 contains a reference 814 to the primary key 813 in the ConceptQualifierList1 class 804; the ConceptQualifier1 q2 class 807 contains a reference 815 to the primary key 813 in the ConceptQualifierList1 class 804; and the ConceptQualifier1q3 class 806 contains a reference 815 to the primary key 813 in the ConceptQualifierList1 class 804. As illustrated, the ConceptQualifierList1 class 804 references three ConceptQualifier classes 805, 806, 807. Each ConceptQualifier class can be referenced and associated with distinct ConceptDescriptor classes as illustrated in the following illustrations and examples.

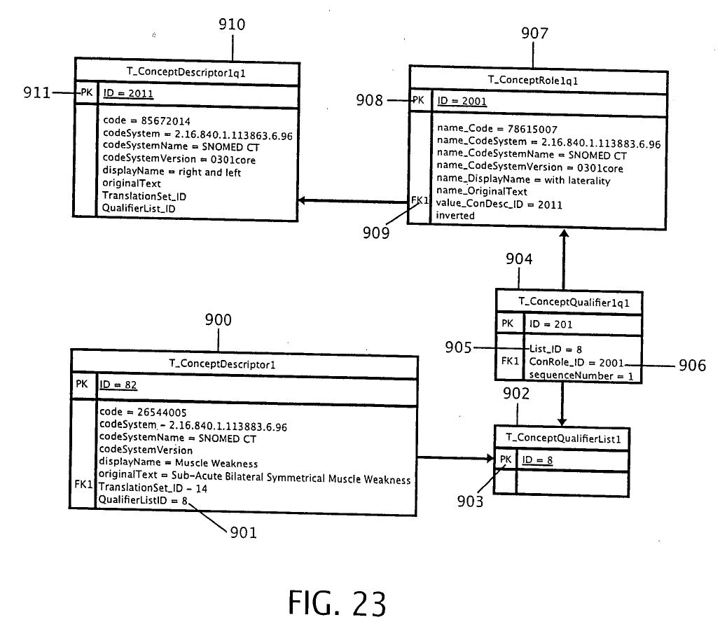

FIG. 23 illustrates further references and associations in accordance with an exemplary embodiment of the concept descriptor. In the embodiment illustrated, the ConceptDescriptor1 class 900 contains a reference 901 to the ConceptQualifierList1 class 902. The reference 901 in the ConceptDescriptor1 class 900 is equal to the primary key 903 in the ConceptQualifierList1 class 902. The ConceptQualifier1q1 class 904 contains a reference to the primary key 903 in the ConceptQualifierList1 class 902 and a foreign key 906. The foreign key 906 in the ConceptQualifier1q1 class 904 references equals the primary key 908 in the ConceptRole1q1 class 907. The ConceptRole1q1 class 907 contains a foreign key 909 which references equals the primary key 911 in the ConceptDescriptor1q1 class 910. As illustrated, the ConceptQualifier1q1 904 class is referenced and associated with a distinct ConceptRole and ConceptDescriptor class.

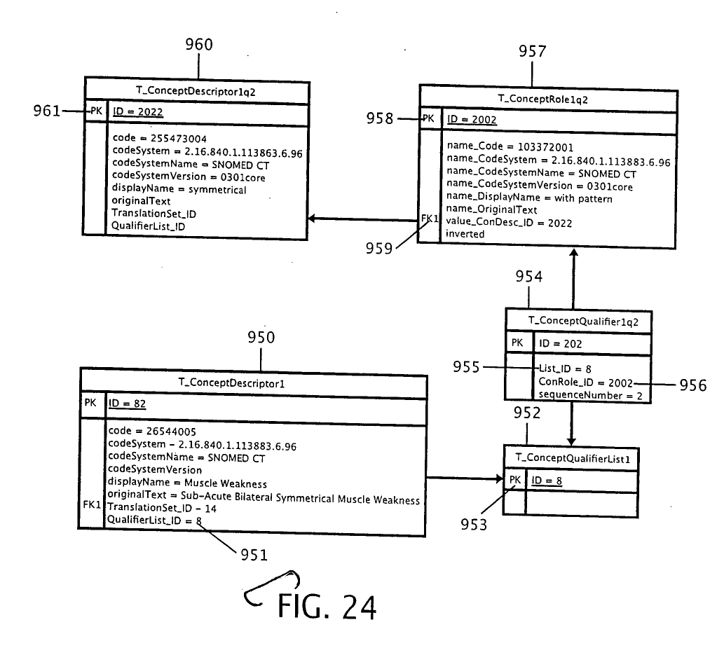

FIG. 24 illustrates further references and associations in accordance with an exemplary embodiment of the concept descriptor. In the embodiment illustrated, the ConceptDescriptor1 class 950 contains a reference 951 to the ConceptQualifierList1 class 952. The reference 951 in the ConceptDescriptor1 class 950 is equal to the primary key 953 in the ConceptQualifierList1 class 952. The ConceptQualifier1q2 class 954 contains a reference to the primary key 953 in the ConceptQualifierList1 class 952 and a reference 956 to the primary key 958 in the ConceptRole1q2 class 957. The ConceptRole1q2 class 957 contains a foreign key 959 which references equals the primary key 961 in the ConceptDescriptor1q2 class 960. As illustrated, the ConceptQualifier1q2 class 954 is referenced and associated with a distinct ConceptRole and ConceptDescriptor class.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A database translation architecture comprising:
an object model for defining a variety of health-related classes;
a plurality of data bridge/data set pairs wherein each data bridge is coupled to the object model;
a plurality of external components coupled to all but one of the data bridge/data set pairs of the plurality of data bridge/data set pairs wherein the plurality of external components are operative to send and receive data in formats unique to each external component such that each format is translated to and from the object model by each corresponding data bridge/data set pair; and
a database coupled to a remaining data bridge/data set pair not coupled to an external component wherein the database is responsive to data queries from the object model as translated by the remaining data bridge/data pair and the database and operative to deliver requested data back to the object model through the remaining data bridge/data set pair which is in turn sent to an external component that originally initiated the data query.

2. A system that can combine well defined, but new, datatypes comprising:
a concept descriptor,
wherein said concept descriptor uniquely identifies data blocks for storage and retrieval.
